(19) United States
(12) Patent Application Publication
(10) Pub. No.: US 2004/0080933 A1
(43) Pub. Date: Apr. 29, 2004

(54) Torch and a method of operating a torch

(76) Inventor: Robert Cheetham, North Devon (GB)

Correspondence Address: Kenneth I Kohn, Kohn & Associates, Suite 410, 30500 Northwestern Highway, Farmington Hills, MI, 48334, US

(21) Appl. No.: 10/467,133

(22) PCT Filed: Feb. 4, 2002
(86) PCT No.: PCT/GB02/00460

(30) Foreign Application Priority Data
Feb. 2, 2001 (GB) 0102707.7

(51) Int. Cl. F21L 4/04

(52) U.S. Cl. 362/205

(57) ABSTRACT

A torch (10) has a magnet (56) in a passageway (54; 68). Movement of the torch (10) in a flicking motion sends the magnet (56) along the passageway (54; 68) to a position adjacent a reed switch (48). Actuation of the reed switch (48) by the magnet (56) turns on the torch (10).

The invention relates to a torch and a method of operating a torch.

Known torches commonly have push button switches. A known waterproof torch has a flexible elastomeric diaphragm arranged over the switch to protect it from ingress of water. This diaphragm is a weak point and if it tears, or simply fractures over time, water will enter the switch and interfere with this operation.

Naturally it is normally dark when one wishes to turn on a torch and the need to locate a switch and press it takes time. The switch may also be difficult to locate and press for example if you are wearing gloves.

According to one aspect of the invention there is provided a torch containing a switch which is activated by movement of the torch.

The switch may be internal, and as it is activated by movement, the torch can be made completely waterproof and preferably the torch includes a watertight casing. As the entire torch is moved in order to actuate the switch and turn the torch on, there is no problem of locating an external switch and pressing it and the torch can readily and quickly be turned on, even by someone wearing gloves in the dark, for example.

Preferably, the switch includes an element to which momentum is imparted by movement of the torch so that the element travels to an actuating position. Preferably, the element is retained in the actuating position and preferably is retained by friction, surface tension, magnetism or the like. The element may take any suitable form and may comprise a magnet which may be arranged to actuate a reed switch.

The torch may be of any suitable construction and may include a head and a body. In that case, the switch is preferably in the head of the torch. The torch may include a bore along or parallel to the longitudinal axis of the torch to form a passageway along which the element can move in to and out of the actuating position. The passageway is conveniently in the head of the torch. In one embodiment the torch includes a second bore parallel to the first bore to receive the other part of the switch. At least part of the switch may be carried by an insert in one embodiment. In that case, the said passageway may conveniently be in the insert. The insert may also conveniently include a bore to receive the other part of the switch. In that case, the bore may be substantially perpendicular to the passageway. The insert furthermore carries the light source. There may be an electrical connection to the insert and in a preferred embodiment at least one spring finger extends from the insert to form an electrical connection.

The light source of the torch may be of any suitable type and may comprise at least one LED. The or each LED may be mounted on a circuit board. Preferably, the circuit board bridges the front aperture or apertures between the light source and power source and is sealed across the or each aperture with sealant adhesive.

According to another aspect of the invention there is provided a method of operating a torch, the method comprising moving the head of the torch with a flicking motion.

Preferably, the torch is a torch according to a first aspect of the invention and including any or none of the sub features mentioned in relation thereto.

Two embodiments of the invention will now be described by way of example and with reference to the accompanying drawings, in which:

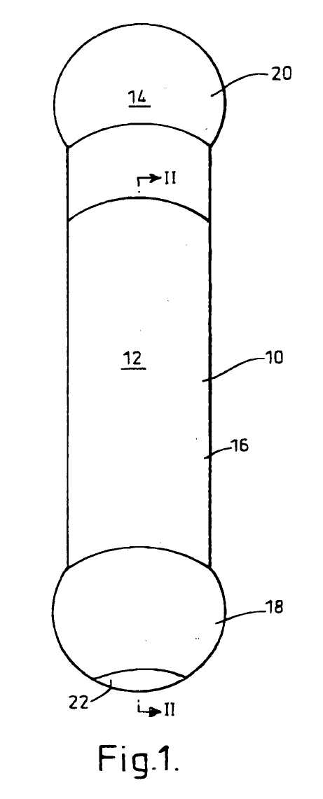

FIG. 1 is a perspective view of a torch in a first embodiment of the invention;

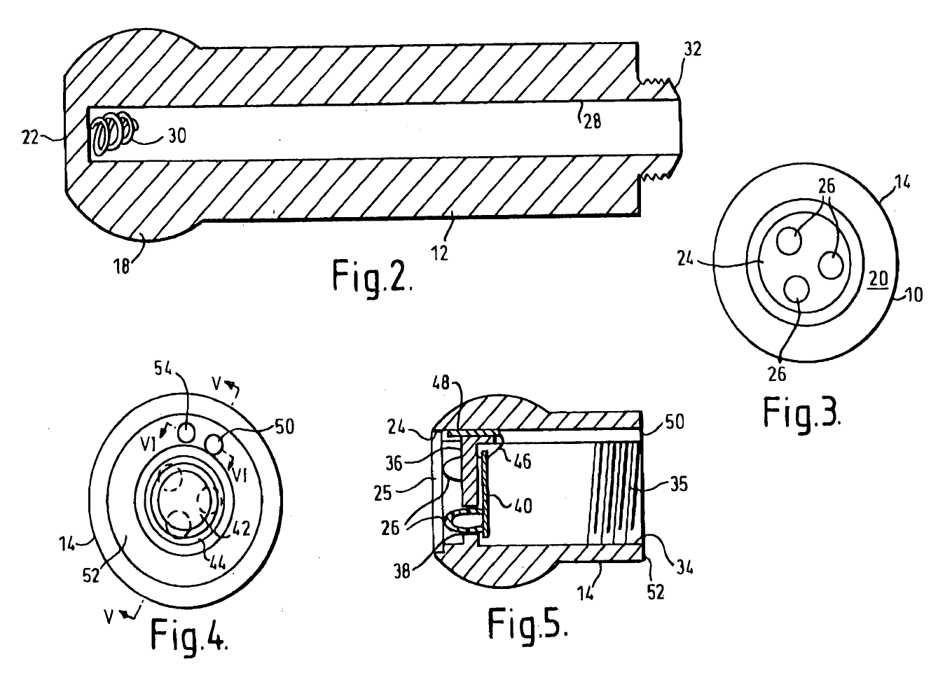

FIG. 2 is a side elevation in cross section of the handle part of the torch of FIG. 1 at II-II;

FIG. 3 is a front elevation of the torch of FIG. 1;

FIG. 4 is a rear elevation of the head part of the torch of FIG. 1;

FIG. 5 is a side elevation in cross section at V-V of the head part of the torch of FIG. 1;

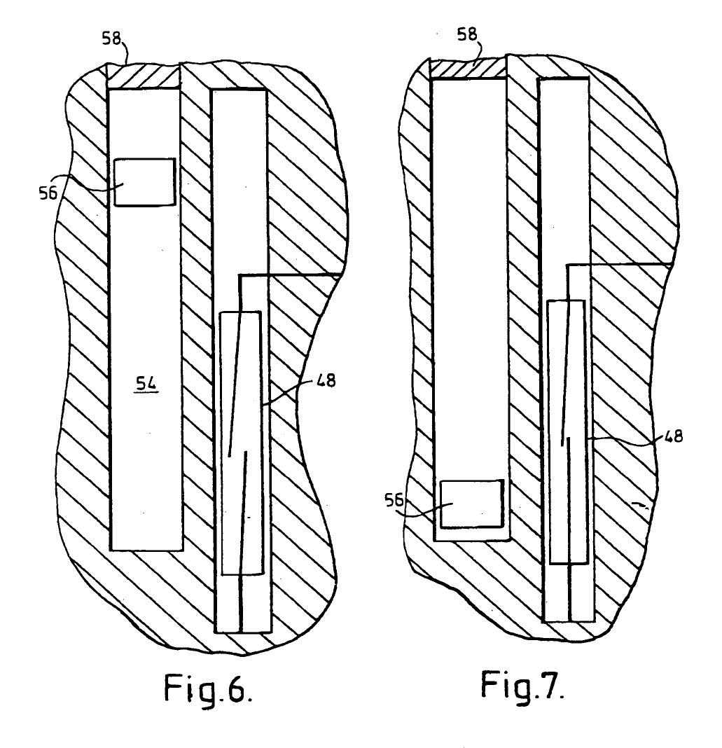

FIGS. 6 and 7 are fragmentary detail views of the switch in the head part of the torch at VI-VI in FIG. 4 showing the switch open and closed respectively; and

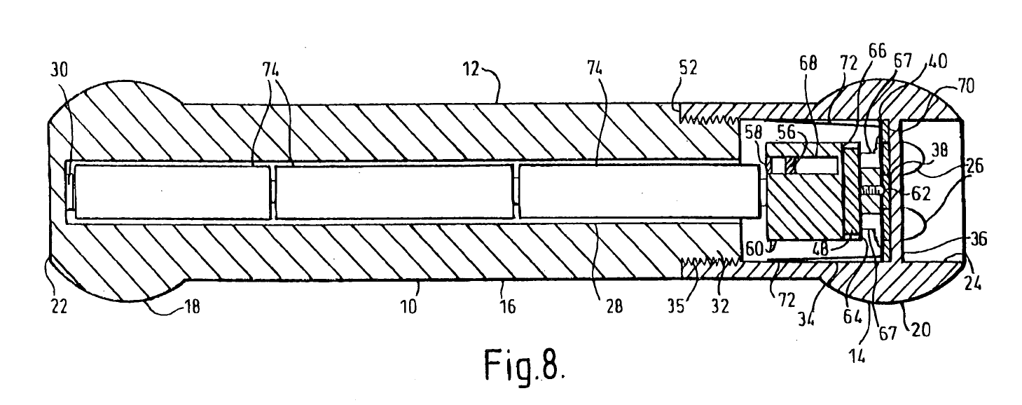

FIG. 8 is a side elevation in cross-sectioning a torch in a second embodiment of the invention.

The torch 10 of the first embodiment of the invention comprises a handle part 12 and a head part 14 which are screwed together to assemble the torch 10.

When the torch 10 is assembled it is generally in the shape of a central cylinder 16 intersecting a sphere 18, 20 at each end, the spheres 18, 20 being aligned with the axis of the cylinder 16 and being of equal size, the spheres 18, 20 being truncated at their outer ends in a plane radial to the axis of the cylinder part 16. The rear surface 22 of the torch 10 is flat, but the truncation of the front sphere 20 leads into a rebate 24 into which three light emitting diodes 26 protrude forwardly, equally spaced about the longitudinal axis of the torch 10. The rebate 24 is stepped to mount a protective transparent cover 25 in front of the LED's 26.

The handle part 22 has an axial blind bore 28 reaching almost to the truncation surface 22. At the blind end of the bore 28 is a helical spring 30. At the other end of the handle part 12 extends a screw threaded cylindrical boss 32 coaxial with the bore 28 and through which the bore 28 also extends.

The head part 14 includes an axial bore 34 which is wider than the bore 28 and is screw threaded over the first part 35 of its length to mate with the externally screw threaded boss 32 of the handle part 12. The bore 34 terminates at a septum 36 separating the bore 34 from the rebate 24. The septum 36 includes three apertures 38 through which the LED's 26 protrude. The LED's 26 are mounted on to a circular circuit board 40 which is mounted to the rear surface of the septum 36 inside the torch 10. The circuit board 40 mounts a central contact disc 42 and an outer contact annulus 44 concentric with the central disc 42. The contacts of each LED 26 are connected one to the central disc 42 and one to the concentric annulus 44. The annulus 44 is connected through a wire 46 to a reed switch 48. The other contact of the reed switch 48 is in contact with the body of the head part 14 which is made of conductive material, such as steel. The reed switch 48 is provided in a bore 50 which extends parallel to the longitudinal axis of the head part 14 from the rear surface 52 of the head part 14 almost into the rebate 24. The bore 50 for the reed switch 48 intersects the bore 34 allowing connection of the circuit board 40 to the reed switch 48 by means of the wire 46 passing between the two bores 34, 50. A further bore 54 extends parallel to the bore 50 from the rear surface 52 of the head part 14 and lies close to the bore 50 but at a greater radial distance from the axis of the head part 14 so that it does not intersect the main bore 34. The bore 54 is almost as long as the bore 50. A cylindrical permanent magnet 56 slides within the bore 54. There is a small amount of oil in the bore 54 so that there is a film of oil on the walls of the bore 54 resulting in a resistance, albeit low, to movement of the magnet 56. The rear end of the bore 54 is plugged by a solid cylindrical elastomeric plug 58.

In use, batteries (not shown) are inserted into the bore 28 in the handle part 12 and the head part 14 is screwed on to the handle part 12 with the screw threaded boss 32 being received in the bore 34 in the head part 14. The end of the forward most battery will be received in the head part 14 and will contact the contact disc 42 so that a circuit is formed through the batteries, the contact disc 42, the LED's 26, the annular contact 44, the wire 46, the reed switch 48, the casing of the head part 14, the casing of the handle part 12 and back through the spring 30 to the batteries. The permanent magnet 56 starts in its rest position adjacent the plug 58 at the rear of the bore 54. When a user holds the torch 10 and flicks the head 14 forwards, momentum is imparted to the permanent magnet 56 to overcome the frictional resistance so that the magnet 56 travels along the bore 54 until it lies adjacent the reed switch 48. In this position as shown in FIG. 7 the magnetic field from the magnet 56 will cause the contacts of the reed switch 48 to come together making a circuit and lighting the LED's 26. The resistance to movement of the magnet 56 is such that the torch 10 can be pointed at the ceiling for example and the magnet 56 will stay in place and the reed switch 48 will remain closed. If the torch 10 is pointed upwards and tapped on its base however the magnet 56 will travel back down the bore 54 away from the reed switch 48. The contacts of the reed switch 48 will come apart as the magnet 56 moves away and the torch 10 will be turned off.

It is thus seen that the torch 10 can be switched on easily by a flicking motion. The user does not have to find a switch and press it, which can be fiddly, and may not be possible for those with certain disabilities. In addition, the torch is entirely waterproof.

The second embodiment is similar to the first and the same reference numerals will be used for equivalent features. Only the differences from the first embodiment will be described.

In the first embodiment, the reed switch 48 and magnet 56 were provided in bores in the conductive metal head 14. In the second embodiment, an additional body 60 is provided. This body 60 is generally in the form of a solid, conductive, metal cylinder of smaller diameter than the diameter of the bore 34 in the head 14. The body 60 is mounted coaxially within the bore 34 by means of a nylon screw 62 which attaches the body 60 to the circuit board 40. The body 60 has an inward step 64 at its front end. Just behind the step 64 is provided a diametrical bore 66 which receives and mounts the reed switch 48. Wires 67 from the LED's 26 and circuit board 40 are connected to the reed switch 48. A further bore 68 is provided in the body 60. The bore 68 is parallel to the axis of the body 60 but radially offset therefrom. The bore 68 just intersects the bore 66. The magnet 56 is slidable in the bore 68 in the same manner as the first embodiment, and the rear end of the bore 68 is plugged by a neoprene plug 58. The magnet 56 is a neodymium magnet with a polished finish so that it slides easily in the bore 68. The circuit board 40 is attached to the septum 36 by a layer of waterproof sealant adhesive 70 which prevents water from entering the torch 10 through the apertures 38 in the septum 36.

In the second embodiment there are four LED's 26 which are equally spaced about the central axis of the torch 10. Two resilient wire fingers 72 extend rearwardly and outwardly from the lower side of the circuit board 40 and contact the sides of the bore 34 in the head 14. The fingers 72 are on opposed sides of the circuit board 40.

In order to assemble the torch 10 of the second embodiment, the magnet 56 is inserted into the bore 68 and the end of the bore is plugged with the plug 58. The reed switch 48 is inserted into the bore 66 in the body 60. The circuit board 40 carrying the LED's 26 is screwed to the front end of the body 60 by means of the screw 62 and the connections to the reed switch 48 are made. Adhesive sealant is then applied to the rear surface of the septum 36 and the insert consisting of the LED's 26, circuit board 40 and body 60 is pushed into the bore 34 in the head 14 of the torch 10. The fingers 72 are pushed inwards by engagement with the walls of the bore 34 to make good electrical contact therewith. The LED's 26 penetrate through the apertures 38 in the septum 36 and the circuit board 40 adheres to the rear surface of the septum 36.

Three batteries 74 are inserted into the bore 28 in the handle part 12. The handle part 12 and head part 14 are then screwed together such that the terminal on the end of the front battery 74 contacts the rear surface of the body 60 and is biased against it by the action of the spring 30 at the end of the bore 28.

The torch 10 is then ready for use. The torch 10 is operated in the same manner as the first embodiment by flicking the head of the torch 10 so that the magnet 56 travels along the bore 68 to adjacent the reed switch 48. The reed switch 48 is operated by the proximity of the magnet 56 resulting in illumination of the LED's 26. A circuit is thus formed through the batteries 74, the body 60, the reed switch 48, the circuit board 40, the LED's 26, the fingers 72, the head part 14, the handle part 12, and the spring 30 back to the batteries 74.

The magnetic attraction between the magnet 56 and the leaves of the reed switch 48 helps to hold the magnet 56 in place so that the torch stays on even when the torch 10 is pointed upwards. As before, the torch 10 can be turned off simply by tapping the base of the torch 10 so that the magnet 56 falls back away from the reed switch 48. Equally the magnetic attraction between the magnet 56 and the adjacent battery 74, when the magnet is at the opposite end of the bore 68 against the plug 58, helps to prevent the torch from turning itself on if it is simply inverted. A positive flick is required to overcome the magnetic and any frictional forces and result in movement of the magnet 56 to turn on the torch.

In the arrangement described, the magnet 56 arrives at a non-central position along the reed switch 48, but it has been found that the reed switch 48 operates better with the magnet 56 in that offset position. In alternative embodiments however the bore 68 could be, for example, along the central axis of the body 60 so that the magnet 56 arrives centrally of the reed switch 48.

It is to be understood that any suitable number of LED's may be employed. Ultra bright LED's are now available which make a torch with a single LED practical. LED's of different colours are also available and could be employed if desired. Alternatively a filament bulb or other light source may be used, but LED's are preferred for their robustness.

The handle part 12 and head part 14 of the torch 10 may be made of any suitable conductive material such as steel or aluminium. Alternatively, the handle part 12 and/or head part 14 may be made of non-conductive material and connection between the LED's 26 or circuit 40 and the required terminal of the battery or batteries may be made in another known manner.

1. A torch containing a switch which is activated by movement of the torch, the switch including an element to which momentum is imparted by movement of the torch so that the element travels to an actuating position in which the switch is activated magnetically.

2. A torch as claimed in claim 1, wherein the switch is activated by moving the torch with a flicking motion.

3. A torch as claimed in claim 1 or claim 2, wherein the torch includes a watertight casing.

4. A torch as claimed in claim 1, 2 or 3, wherein the element is retained in the actuating position.

5. A torch as claimed in claim 4, wherein the element is retained by friction, surface tension, magnetism or the like.

6. A torch as claimed in any preceding claim wherein the element is a magnet.

7. A torch as claimed in claim 6, wherein the magnet is arranged to actuate a reed switch.

8. A torch as claimed in any preceding claim, wherein the torch includes a passageway along which the element can move into and out of the actuating position.

9. A torch as claimed in claim 8, wherein the passageway is along or substantially parallel to the longitudinal axis of the torch.

10. A torch as claimed in claim 8 or claim 9, wherein the torch includes a head and a body.

11. A torch as claimed in claim 10, wherein the passageway is a bore into the casing of the head or body.

12. A torch as claimed in claim 11, wherein the bore commences at the junction between the head and body.

13. A torch as claimed in claim 12, wherein the bore is in the head of the torch.

14. A torch as claimed in any of claims 10 to 13, wherein the torch includes a bore to receive the other part of the switch.

15. A torch as claimed in claim 14, wherein the bore to receive the other part of the switch is parallel to the passageway and alongside it.

16. A torch as claimed in any preceding claim, wherein at least part of the switch is carried by an insert.

17. A torch as claimed in claim 16 when dependent on claim 8, wherein the passageway is in the insert.

18. A torch as claimed in claim 17, wherein the passageway is a bore in the insert.

19. A torch as claimed in claim 16, 17 or 18, wherein the insert mounts the other part of the switch.

20. A torch as claimed in claim 19, wherein the insert defines a bore to receive the other part of the switch.

21. A torch as claimed in claim 20, wherein the bore to receive the other part of the switch is substantially perpendicular to the passageway.

22. A torch as claimed in any of claims 16 to 21, wherein the insert carries the light source.

23. A torch as claimed in any of claims 16 to 22, wherein at least one spring finger extends from the insert to form an electrical connection.

24. A torch as claimed in any preceding claim, wherein the light source of the torch comprises at least one LED.

25. A torch as claimed in claim 24, wherein the or each LED is mounted on a circuit board.

26. A torch as claimed in claim 25, wherein the circuit board bridges the front aperture or apertures and is sealed across the or each aperture with sealant adhesive.

27. A torch substantially as described herein with reference to FIGS. 1 to 7 or 8 of the accompanying drawings.
